(19) United States
(12) Patent Application Publication
(10) Pub. No.: US 2006/0099274 A1
(43) Pub. Date: May 11, 2006

(54) Expulsive liquid for exterminating disease injury of plants

(75) Inventor: Yousuke Saitou, Aichi-ken (JP)

Correspondence Address: NIXON & VANDERHYE, PC, 901 NORTH GLEBE ROAD, 11TH FLOOR, ARLINGTON, VA, 22203, US

(73) Assignee: HOSHIZAKI DENKI KABUSHIKI KAISHA, Toyoake-shi (JP)

(21) Appl. No.: 10/985,002

(22) Filed: Nov. 10, 2004

(51) Int. Cl. A01N 59/00

(52) U.S. Cl. 424/600

(57) ABSTRACT

Expulsive liquid for exterminating disease injury of plants in a growing process, consisting of electrolyzed strong acid water produced by electrolysis of diluted aqueous solution of inorganic salt in an electrolytic cell with an ion-permeable membrane, the electrolyzed strong acid water being adjusted in pH to an extent of 2-4, in oxidation-reduction potential to an extent of 800-1400 mV and in effective chlorine concentration to an extent of 0-60 mg/L before sprayed on the plants. The effective chlorine concentration is adjusted in the extent of 0-60 mg/L taking into account the kind of plants, an infected condition of the plants and a portion of the plants to be sprayed.

### BACKGROUND OF THE INVENTION

1. Field of the Invention

The present invention relates to expulsive liquid for exterminating disease injury of plants used to be sprayed on plants in a growing process.

2. Discussion of the Prior Art

As a method of exterminating disease injury of plants, agricultural chemicals with germicide resolution are, in general, sprayed on plants in a growing process. In such a method of extermination, the agricultural chemicals remain on the plants, resulting in pollution of soil. For this reason, it is noticed to substitute electrolyzed strong acid water with germicide resolution for agricultural chemicals. For example, proposed in Japanese Patent Laid-open Publication No. 2000-159618 is a method of exterminating disease injury of plants by using electrolyzed strong acid water of more than 50 ppm in effective chlorine concentration. Although the Publication No. 2000-159618 discloses disinfection methods of plant seeds and soil for extermination of disease injury of plants, there is not disclosed any method of exterminating disease injury of plants in a growing process.

### SUMMARY OF THE INVENTION

It is, therefore, a primary object of the present invention to provide expulsive liquid in the form of electrolyzed strong acid water replaceable with agricultural chemicals for exterminating disease injury of plants in a growing process without causing any damage on the plants.

According to the present invention, the object is attained by providing expulsive liquid for exterminating disease injury of plants in a growing process, which is in the form of electrolyzed strong acid water produced by electrolysis of diluted aqueous solution of inorganic salt in an electrolytic cell with an ion-permeable membrane and adjusted in pH to an extent of 2-4, in oxidation-reduction potential to an extent 800-1400 mV, and in effective chlorine concentration to an extent of 0-60 mg/L before sprayed on plants.

In a practical embodiment of the present invention, it is preferable that the electrolyzed strong acid water is left in an atmospheric air for a predetermined time for adjustment of its effective chlorine concentration. It is also preferable that sodium thiosulfate or sodium ascorbate is added to the electrolyzed strong acid water for adjustment of the effective chlorine concentration.

In another practical embodiment of the present invention, it is preferable that the effective chlorine concentration is adjusted to a desired value in the extent of 0-60 mg/L when the electrolyzed strong acid water is sprayed on the plants.

### BRIEF DESCRIPTION OF THE DRAWINGS

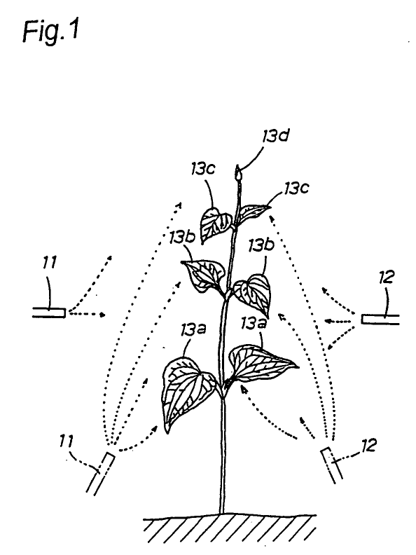

In the drawing, FIG. 1 illustrates a cultivated condition of a seedling of cucumber in a growing process which is sprayed with electrolyzed strong acid water as expulsive liquid.

### DESCRIPTION OF THE PREFERRED EMBODIMENTS

In an experiment where electrolyzed strong acid water produced by electrolysis of diluted solution of inorganic salt in an electrolytic cell with an ion-permeable membrane was used as expulsive liquid to exterminate disease injury of plants, the inventor has found the facts that the germicide resolution of the electrolyzed strong acid water differs in accordance with the kind of disease of plants and that an influence of damage caused by the electrolyzed strong acid water differs in accordance with the kind of plants and the growing degree of the plants.

Based on such facts in the experiment, the inventor has found that it is necessary to adjust the germicide resolution of the electrolyzed strong acid water in accordance with the kind of disease of plants to be exterminated and the growing degree of a portion of the plants to be sprayed. In respect of the expulsive characteristic of the electrolyzed strong acid water, the inventor has found the facts that the germicide resolution to the pathogenic fungus of infection is mainly caused by pH and an effective chlorine concentration and that the resolution of damage is mainly caused by the effective chlorine concentration and appeared as change of color and decoloration of leaves.

For the purpose of exterminating disease injury of plants, the inventor produced electrolyzed strong acid water by electrolysis of diluted aqueous solution of inorganic salt in an electrolytic cell with an ion-permeable membrane and adjusted the electrolyzed strong acid water in pH to an extent of 2-4, in oxidation-reduction potential to an extent of 800-1400 mV and in effective chlorine concentration to an extent of 0-60 mg/L. When the electrolyzed strong acid water is sprayed on plants in a growing rocess, the effective chlorine concentration was appropriately adjusted in an extent of 0-50 mg/L as described below.

For adjustment of the effective chlorine concentration, the electrolyzed strong acid water was left in an atmospheric air for a predetermined time immediately after produced in the electrolytic cell. In such a case, the electrolyzed strong acid water may be exposed to sunshine or left in shadow. For example, in the case that the electrolyzed acid strong acid water is left in an atmospheric air for one week immediately after produced in the electrolytic cell, it is able to adjust the effective chlorine concentration of the electrolyzed strong acid water from about 45 mg/L to zero for preparation of expulsive liquid of a desired concentration. For adjustment of the effective chlorine concentration, the electrolyzed strong acid water may be added with an amount of sodium thiosulfate or sodium ascorbate immediately after produced or prior to use to decrease the effective chlorine concentration for preparation of expulsive liquid of a desired concentration.

The effective chlorine concentration of the electrolyzed strong acid water may be adjusted when sprayed on plants in a growing process. In such a case, particles of electrolyzed strong acid water ejected from a spray nozzle are adjusted in diameter or a distance of a spray nozzle of electrolyzed strong acid water apart from plants to be sprayed. In the former adjustment method, openings of the spray nozzle and ejection pressure of the electrolyzed strong acid water are adjusted to appropriately adjust particles of the sprayed acid water in diameter to an extent of 20 μm-200 μm. In this instance, an amount of the air per unit in contact with the electrolyzed strong acid water changes in accordance with the particle diameter of the sprayed strong acid water, and the effective chlorine concentration of the electrolyzed strong acid water immediately before adhered to the plants changes in accordance with the particle diameter of the sprayed strong acid water. Thus, the effective chlorine concentration of the electrolyzed strong acid water is increased or decreased in accordance with the particle diameter of the strong acid water sprayed on the plants and is appropriately adjusted to a desired value in an extent of 45 mg/L to zero in a condition adhered to the plants as expulsive liquid.

In the latter adjustment method, a distance of a spray nozzle of the electrolyzed strong acid water apart from the plants is adjusted to change an amount of the air per unit in contact with the acid water thereby to increase or decrease the effective chlorine concentration of the acid water immediately before adhered to the plants. Thus, the effective chlorine concentration of the electrolyzed strong acid water is appropriately adjusted to a desired value in an extent of 45 mg/L to zero in a condition adhered to the plants as expulsive liquid. As described above, the effective chlorine concentration of the expulsive liquid in the form of the electrolyzed strong acid water is adjusted in accordance with an infected condition of the plants, the kind of the plants and a portion of the plants to be sprayed with the acid water. This is effective to sufficiently exterminate the diseases of the plants without causing any damage.

In a practical embodiment of the present invention, it is preferable that the electrolyzed strong acid water is produced by electrolysis of diluted aqueous solution (for instance, 0.15˜0.25 wt. %) of potassium chloride or sodium chloride in an electrolytic cell with an ion-permeable membrane. The expulsive liquid in the form of electrolyzed strong acid water is effective to exterminate disease injury of plants suitable for topping-cultivation such as cucumbers, eggplants, tomatoes, melon or the like.

Illustrated in FIG. 1 is a cultivated condition of a cucumber in a growing process which is sprayed with electrolyzed strong acid water as expulsive liquid. To exterminate disease injury of the cucumber, spray nozzles 11 and 12 are placed as shown solid lines to uniformly spray the expulsive liquid to stalks of the cucumber or placed at the base of the cucumber as shown by two-dots and dash lines to spray the expulsive liquid toward tips of the stalks. In such spray method of the expulsive liquid, old leaves 13a, 13b of the cucumber are located most near the spray nozzles 11, 12, while sprouts 13c of the cucumber are apart from the spray nozzles. 11, 12.

Practical Embodiment:

In an experiment for exterminating powdery mildew of a cucumber in a growing process, the expulsive liquid in the form of the electrolyzed strong acid water was directly sprayed on the seedling of cucumber in a growing process cultivated in a condition described below to confirm the germicide effect (extermination effect of disease) thereof and to observe change of color of leaves of the cucumber at respective portions.

In the cultivation of the cucumber, seedlings of a cucumber were cultivated for four weeks after seeded in a seed-bed, transplanted each ten pieces in three different nursery beds and grown until a time of harvesting (for eighteen weeks after seeded). During such a period of cultivation, electrolyzed strong acid water produced as described below was sprayed on the seedlings of the cucumbers to exterminate powdery mildew thereon.

The electrolyzed strong acid water was produced by electrolysis of diluted aqueous solution of 0.2 wt. % potassium chloride in an electrolytic cell with an ion-permeable membrane (ROX-15SA made by Hoshizaki Electric Co. Ltd.) and adjusted in its effective chlorine concentration to 43 mg/L, in pH to 2.53, in oxidation-reduction potential to 1120 mV and in conductive degree to 2690 μs/cm.

In this experiment, the electrolyzed strong acid water was stored in a storage tank immediately after produced and left for three days at a sunshiny place to prepare a first sample (1) of expulsive water whose effective chlorine concentration is zero. In addition, a second sample (2) of expulsive liquid was prepare by the electrolyzed strong acid water whose effective chlorine concentration is 43 mg/L. The first and second samples of expulsive liquid are listed in the following table.1.

TABLE 1

Expulsive liquid

| Characteristic | Sample (1) | Sample (2) |
|---|---|---|
| pH | 2.4 | 2.52 |
| ORP(mV) | 1090 | 1120 |
| Effective chlorine(mg/L) | 0 | 43 |
| Ec (μs/cm) | 2770 | 2690 |

ORP: Oxidation-reduction potential
Ec: Conductive degree

To spray the expulsive liquid on the cucumbers, spray nozzles were placed as shown in FIG. 1 to uniformly spray the expulsive liquid onto the entirety of the seedlings of cucumber transplanted to first and second nursery beds. Provided that, the seedlings of cucumber transplanted in a third nursery bed was not sprayed with the expulsive liquid. Spray of the expulsive liquid to the first and second nursery beds was carried out three times at seven days interval after lapse of eleven weeks from the occurrence of powdery mildew on the cucumbers. The expulsive liquid was sprayed on the seedlings of cucumber in each amount of 20 cc/one leaf so that both surfaces of each leaf are sufficiently wetted with the expulsive liquid.

To confirm the extermination effect of disease injury, an average value of each infection area of the old leaves 13a, 13b and sprouts 13c, 13d was measured immediately after spray of the expulsive liquid. To confirm influence caused by spray of the expulsive liquid, each change degree of color of the old leaves 13a, 13b and sprouts 13c, 13d was observed to evaluate at two stages immediately after spray of the expulsive liquid. A result of the measurement and observation is shown in the following table 2.

TABLE 2

| | Spray of | | | |
|---|---|---|---|---|
| | expulsive liquid | Infection area | Damage | Change of color |
| First | Before spray | 11.9% | — | None |
| nursery: | First spray | 28.3% | — | None |
| | Second spray | 49.7% | — | None |
| | Third spray | 25.4% | — | None |
| Second | Before spray | 13.5% | — | None |
| nursey: | First spray | 29.5% | — | None |
| | Second spray | 46.1% | — | None |
| | Third spray | 22.0% | Sprouts | Change |
| Third | Before spray | 12.2% | — | None |
| nursery: | First spray | 41.6% | — | None |
| | Second spray | 53.1% | — | None |
| | Third spray | 71.8% | — | None |

As is understood from the table 2, it has been confirmed that the disease injury was sufficiently exterminated by spray of the samples (1) and (2) of expulsive liquid in cultivation of the cucumbers. In respect to influence of the expulsive liquid to the cucumbers, any damage did not occur in the cucumbers cultivated in the first nursery bed. In the second nursery bed, it has been found that change of color and damage of the sprouts 13d and 13c were caused by spray of the sample (2) of expulsive liquid.

From the result described above, it has been found that the expulsive liquid sprayed for extermination of powdery mildew is effective mainly in its strong acidity and effective auxiliary in its effective chlorine concentration. From this fact, it has been confirmed that reduction of the effective chlorine concentration of the expulsive liquid is effective to enhance the extermination effect of powdery mildew of cucumbers without causing any damage of the cucumbers.

From the foregoing facts, it has been confirmed that the best method for extermination of various kinds of disease injury of plants is to adjust the effective chlorine concentration of the electrolyzed strong acid water in accordance with infected conditions of the plants, the kind of plants and a portion to be sprayed thereby to correspond the resolution of extermination with the infected conditions and to correspond the resolution of damage with the resolution of anti-damage of the kind of plants and the portion to be sprayed.

What is claimed is:

1. Expulsive liquid for exterminating disease injury of plants in a growing process, consisting of electrolyzed strong acid water produced by electrolysis of diluted aqueous solution of inorganic salt in an electrolytic cell with an ion-permeable membrane and adjusted in pH to an extent of 2-4, in oxidation-reduction potential to an extent of 800-1400 mV and in effective chlorine concentration to 0-60 mg/L before sprayed on the plants.

2. Expulsive liquid as claimed in claim 1, wherein the electrolyzed strong acid water is left in an atmospheric air for a predetermined time for adjustment of its effective chlorine concentration.

3. Expulsive liquid as claimed in claim 1, wherein the electrolyzed strong acid water is added with an agent for reduction of effective chlorine for adjustment of the effective chlorine concentration.

4. Expulsive liquid as claimed in claim 3, wherein sodium thiosulfate or sodium ascorbate is added to the electrolyzed strong acid water for adjustment of the effective chlorine concentration.

5. Expulsive liquid for exterminating disease injury of plants in a growing process, consisting of electrolyzed strong acid water produced by electrolysis of diluted aqueous solution of inorganic salt in an electrolytic cell with an ion-permeable membrane and adjusted in pH to an extent of 2-4, in oxidation-reduction potential to an extent of 800-1400 mV and in effective chlorine concentration to 0-60 mg/L, wherein the effective chlorine concentration is adjusted to a desired value in the extent of 0-60 mg/L when the electrolyzed strong acid water is sprayed on the plants.

6. Expulsive liquid as claimed in claim 5, wherein particles of electrolyzed strong acid water ejected from a spray nozzle is adjusted in diameter for adjustment of the effective chlorine concentration of the acid water.

7. Expulsive liquid as claimed in claim 5, wherein a distance of a spray nozzle of electrolyzed strong acid water apart from a portion of the plants to be sprayed is adjusted for adjustment of the effective chlorine concentration of the acid water.
